(19) United States
(12) Patent Application Publication
(10) Pub. No.: US 2005/0033829 A1
(43) Pub. Date: Feb. 10, 2005

(54) System and method for wireless multicast downloading

(75) Inventor: Paul Oommen, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/635,037

(22) Filed: Aug. 4, 2003

(51) Int. Cl. G06F 15/16; G06F 15/177

(52) U.S. Cl. 709/220; 709/205

(57) ABSTRACT

A method for wireless multicast downloading of data to mobile devices including steps of determining multicast capabilities of the mobile devices; assigning each of the mobile devices to an individual one of a plurality of subgroups of the mobile devices; and determining how to download the data or what type of data to download to the mobile devices based upon the subgroup assignment. The subgroup assignment of the mobile devices is based upon at least one of the multicast capabilities of the mobile devices.

### BACKGROUND OF THE INVENTION

1. Field of the Invention

The present invention relates to wireless multicasting and, more particularly, to managing multicasting of data with mobile devices.

2. Brief Description of Prior Developments

Downloading software over-the-air (OTA) is the most promising method for introducing new software to mobile devices (also known as mobile hosts), such as mobile telephones, mobile communicators, PDAs, etc. Most cases of service provisioning also requires software update. There are common software delivery mechanisms in fixed networks in which data delivery is announced and hosts join to form multicast groups.

A service has at least four phases, negotiation, provisioning, usage, and de-installation. Negotiation is the process when the user discovers a service and decides to subscribe for a desired service. Associated with the provisioning phase is service subscription, which involves downloading of software modules that enable the service in the device. If a group of users subscribed to the same service, it is possible to update the required software using mobile IP multicast protocol. The usage phase involves the end user using the service and the service provider giving continuous management to ensure the level of quality of service. This phase involves software upgrades to enhance the service and possible bug fix updates. While it is possible for each end user to “Pull” the software modules, or the server to update it using unicast methods, both approaches are inefficient, for both a mobile network and a mobile device, in terms of use of network resources and OTA efficiency.

There are several scenarios requiring multicast delivery of data to mobile devices as well as management of the delivery process. The following are some examples of situations requiring multicast delivery and management.
Real time Audio and Video streaming—education and training, live concerts and sports events etc.
Application and service provisioning—provisioning of user services and applications.
Software bug fixing and upgrades.
Update of large data blocks—configuration parameter blocks.
Digital signal processing software and radio access technology software—for multimode reconfigurable mobile devices.
Messaging services—weather alerts, news.

The present invention considers the problem of data delivery to diverse mobile devices. There is diversity in multicast protocols, software modules, device capabilities and subscribed wireless services in diverse mobile devices. An integrated framework is desired for allowing multicast downloading of data to mobile devices. The present invention proposes a mobile centric method, which allows mobile devices to receive software delivered using IP based or lower layer multicast protocols.

Though there are protocols for multicast delivery of software, there is no framework to manage the multicast delivery to a wide variety of devices with different capabilities. There is a need for better management of multicast based software downloading. There are IP based protocols as well as lower layer protocols for multicast delivery of data over the air interface. These protocols are most often used for streaming applications, such as real time telecast of live events, for example. But, many mobile services require delivery and update of software to be installed on mobile devices. A mechanism that allows the management of software delivery, interoperable with different multicast delivery protocols and device capabilities is required.

### SUMMARY OF THE INVENTION

In accordance with one method of the present invention, a method for wireless multicast downloading of data to mobile devices is provided including steps of determining multicast capabilities of the mobile devices; assigning each of the mobile devices to an individual one of a plurality of subgroups of the mobile devices; and determining how to download the data or what type of data to download to the mobile devices based upon the subgroup assignment. The subgroup assignment of the mobile devices is based upon at least one of the multicast capabilities of the mobile devices.

In accordance with another aspect of the present invention, a method for wireless multicast downloading of data to a mobile device is provided comprising steps of requesting download of the data from a service provider to the mobile device by a user of the mobile device; sending multicast capability information regarding the mobile device to a management server at the service provider; grouping identification of the mobile device in a group or subgroup with at least one other mobile device requesting a similar download, the group or subgroup being organized based upon at least one common multicast capability in the multicast capability information of the mobile devices; and determining how to download the data to the mobile device based upon its grouping and the at least one common multicast capability.

In accordance with one aspect of the present invention, a system for managing multicast downloading of data from a service provider to mobile devices having different multicast reception capabilities is provided comprising means for determining information regarding the multicast reception capabilities of individual ones of the mobile devices and transmitting the information to a management server at a service provider; means for assigning the mobile devices to subgroups by the management server based upon commonality of information in the multicast reception capabilities information of the mobile devices; and means for transferring the data to the mobile devices in each subgroup. The means for transferring is adapted to individually configure data transmission for each of the subgroups based upon common or similar information in the multicast reception capability information for the mobile devices for that subgroup.

### BRIEF DESCRIPTION OF THE DRAWINGS

The foregoing aspects and other features of the present invention are explained in the following description, taken in connection with the accompanying drawings, wherein:

FIG. 1 is a schematic diagram of a method for forming groups/subgroups of mobile devices and distributing data to the mobile devices based upon their groups;

FIG. 2 is a schematic diagram of a system incorporating features of the present invention using the method shown in FIG. 1; and

FIG. 3 is a flow chart of one detailed method using the system shown in FIG. 2 incorporating features of the present invention.

### DETAILED DESCRIPTION OF THE PREFERRED EMBODIMENT

The ability to manage multicast downloading enables service providers to provide secure distribution of software and ensuring the level of subscribed quality of service. It helps in configuration, performance and accounting management of subscribed end-user services. Using multicasting, service providers can update software to all mobile devices of a given type.

Group establishment and software delivery process are the two phases of mobile multicast software delivery. In a fixed network, the Internet Group Management Protocol (IGMP) is used for group subscription between the hosts and multicast routers. Accordingly, a user wishing to join the multicast groups sends an IGMP join message to the nearest multicast router. This model works only for devices in the network supporting IP based protocols. There can be non-IP multicasting protocols. For example multicasting can be done over CDMA2000 air interface, the multicast routing being done in a wireless network.

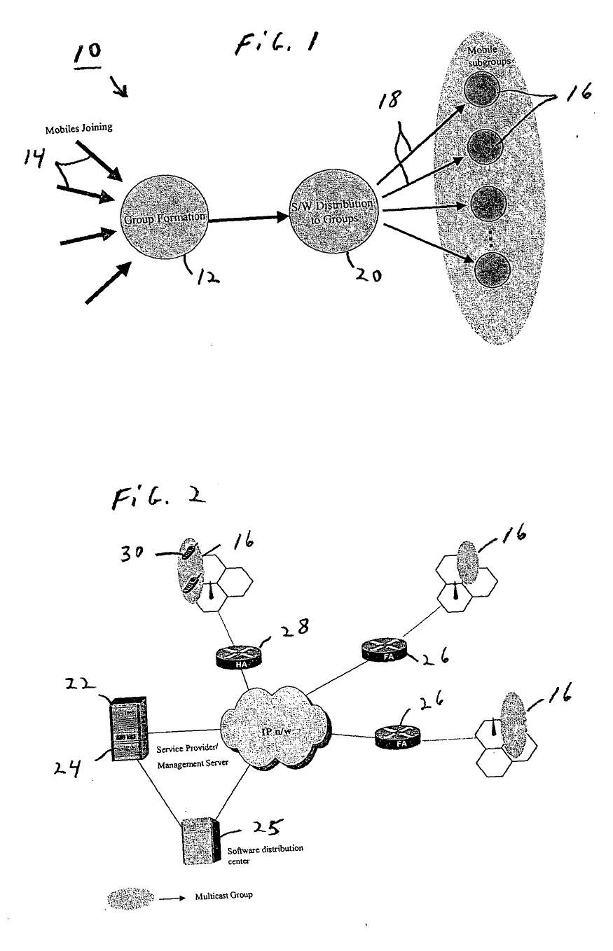

As seen in FIG. 1, the server at the service provider can form group(s) and/or subgroup(s) at a group formation function 12 with mobile devices joining 14 the group(s)/subgroup(s). This forms mobile groups/subgroups 16. The service provider is able to distribute 18 data to the groups(s)/subgroups by a system 20 based upon the group/subgroup assignment appropriate to the commonalities in the multicast capabilities of the mobile devices in each group/subgroup.

Referring to FIG. 1, there is shown a schematic view of a system 10 incorporating features of the present invention. Although the present invention will be described with reference to the exemplary embodiment shown in the drawings, it should be understood that the present invention can be embodied in many alternate forms of embodiments.

In order for the service-providing server to manage the group, there has to be group information available in the management plane. This helps the service-providing server to monitor the members in the group without depending on the multicast routers in the multicast tree.

It is possible for the server to form a global tree containing group information of all the subscribed members in the group. The mobile devices send the multicast capability information to the device management server, based on which the server creates multicast subgroups. Capabilities of mobile hosts may vary depending on the device type, operating system, and protocols supported. In such a diverse scenario, sub-grouping will help the server to efficiently tailor the contents.

The software delivery process, using the device management methods, can include session announcement and initiation, joining the session, authentication, subgroup formation by the server, and software multicast delivery to groups.

In session announcement and initiation, a Synchronization Mark-up Language device management (SyncML DM) notification message can be used to announce a session. The SyncML DM protocol is described in the wireless communications standards SyncML Device Management Protocol, version 1.1.1, October 2002 which is hereby incorporated by reference in its entirety. In alternate embodiments, any suitable notification message could be used. SyncML specifications can be obtained from SyncML Initiative Ltd. and are viewable at http://www.openmobilealliance.org/syncml/downloads.html.

SyncML is a standard, not an application or software. SyncML was formed as an industry initiative to develop and promote a single data synchronization protocol for all types of devices such as PDAs, portable PCs, pagers, and mobile phones. Founded in February 2000, SyncML quickly obtained over 500 supporting organizations with major backing by big industry players such as Nokia, Ericcson, IBM, Lotus, Motorola, Palm, Psion, and Starfish software. Less than a year later, the SyncML specification 1.0 was released.

The SyncML specification was designed with two primary goals in mind:
Synchronize networked data with any mobile device
Synchronize a mobile device with any networked data

To accomplish these goals, SyncML was designed as a platform, network, and application-agnostic protocol, allowing for “any-to-any” synchronization and, thereby, access to more types of data. SyncML is based on XML, so it works especially well handling cases in which network services and devices each store the data being synchronized in different formats, and which use different software systems. SyncML benefits can best be summarized by their six major advantages.
Effectiveness over wireless and wireline networks;
Support of multiple transport protocols and media;
Support of arbitrary networked data;
Enablement of data access from myriad applications;
Built upon existing Internet and Web technologies; and
Optimization for resource limitations of mobile devices.

SyncML works over all networks used by mobile devices, both wireless and wireline. Wireless networks in particular present specific challenges, such as high network latency, limited bandwidth, relatively high packet costs, and low reliability of both data and connectivity. SyncML addresses each of these issues through features like a single request-response message model and use of WAP Binary XML (WBXML).

SyncML supports different transport protocols such as HTTP, WSP (Wireless Session Protocol), OBEX (Bluetooth, IrDA), SMTP, pure TCP/IP networks, and proprietary communication protocols. SyncML supports concurrent synchronization with multiple network data repositories. The protocol does not mandate how data is represented or structured on the device or within the networked data repository after synchronization is complete. SyncML describes how common data formats are represented over a network, with support for common formats such as:
Common personal data formats, like vCard for contact information, vCalendar and iCalendar for calendar, to-do, and journal information
Collaborative objects like e-mail and network news
Relational data
XML and HTML documents
Binary data

SyncML is programming language-independent, making zero assumptions about the programming language on either end of the synchronization. To facilitate rapid deployment of SyncML, the reference code must be provided for a common programming language. However, this does not restrict implementation to this language only.

Mobile devices have limited memory and processor capacity, making the requirement for a small memory footprint very important. In addition, the data exchanged by the SyncML interface itself is small and requires minimal code to transfer it to and from the device. Data exchanged using the protocol is encoded in a binary format to reduce memory requirements for storing received messages and reducing processor resources needed to parse and process that data. SyncML is based upon existing Internet and Web technologies, both having been widely implemented and well tested. This helps ensure easy implementation and interoperability testing.

SyncML is comprised of two protocols: SyncML representation protocol and SyncML Sync Protocol. The first one can be envisioned as guiding the intricacies within the SyncML Framework, while the SyncML Sync protocol guides actions on the SyncML client and server. The SyncML data synchronization protocol is essential for gaining interoperable data synchronization. It essentially defines the protocol for different sync procedures, which occur between a SyncML client and SyncML server in the form of message sequence charts (MSCs). Examples of sync types are two-way syncs between server and client, or one-way syncs between the two.

The SyncML representation protocol is defined by a set of well-defined messages (XML documents or MIME) that are shared between synchronizing devices. It supports data synchronization models that are based upon a request/response command structure, or those based upon a “blind push” structure. The SyncML representation protocol specifies what the result of various synchronization operations should be, based upon a synchronization framework and format that accommodates different data synchronization models.

The server and client are connected over any network transport (HTTP, WSP). The client uses the Sync Client Agent to access the network and send messages to the server via the SyncML Adapter and SyncML Interface (SyncML I/F). The server, or Application A, through the Sync Server Agent, receives or sends messages, and manages the entire sync process through the Sync Engine. A SyncML I/F is merely an API to the SyncML Adapter.

SyncML operations are conceptually bound into a SyncML Package, which is a conceptual frame for one or more required SyncML messages. A SyncML message is a well-formed XML document identified by the SyncML root or document element type. The document consists of a header (SyncHdr element type) and a body (SyncBody element type). The header specifies routing and versioning information, while the body is a container for one or more SyncML Commands. The commands are containers for other element types that describe the specifics of the command, including any synchronization data or meta information. Incorporated here, too, are features such as SyncML Data Formats (a common set of media types for commonly accepted information such as calendars and contacts) and SyncML Capabilities Exchange. (in which a SyncML client and server determine what device, user, and application features each supports) are incorporated.

For example, a mobile phone acts as the SyncML client, and a server acts as the SyncML server. The SyncML client sends a message to the SyncML server regarding changes to data made on the client. The server then synchronizes the data within the SyncML messages with data stored on the server, and returns modifications back to the SyncML client. The SyncML client contains a sync client agent, and typically has the role of sending modifications first to the server. The client is typically a mobile phone or PDA, and must also be capable of receiving messages back from the server. The SyncML server contains the sync server agent and the sync engine, and usually waits for the client to initiate synchronization, although the server can initiate synchronizations if unsolicited commands are supported on the transport protocol level.

The trigger body in the notification can carry information about the purpose of the notification, which in this case is session announcement for multicast downloading. In the step of joining the session, the session announcement notification causes the mobile hosts to initiate a connection to the server. A SyncML DM Package #1 message sent by the mobile device can carry the device capability information. The DevInfo extensions of SyncML DM can be used to specify the device capabilities for mobile multicast. DevInfo extensions are described in wireless communications standards SyncML Notification Initiated Session, version 1.1.1, October 2002 which is hereby incorporated by reference in its entirety. However, in alternate embodiments, any suitable type of signals could be used to sent the mobile device capability information. In a preferred embodiment, the DevInfo would be standardized for multicast support.

In the authentication step, a standard SyncML DM authentication procedure can be carried out before secure multicasting happens. Additionally, authentication can be done based on user profile and capability information. Also the server can request a secure PIN. In the subgroup formation step by the server, the server forms multicast subgroups based on mobile device capabilities, and/or the data to be delivered. The server constructs the management tree based on the information from mobile devices. This management tree is different from a first type of multicast management tree used by IP based multicast protocols in the mobile devices. The server multicast tree is for the purpose of routing of multicast data in the network. This second type of server multicast management tree is based on mobile capabilities and is used for efficiently distributing multicast data to groups and subgroups.

The step of software multicast delivery to groups is a two step process. First multicast data is routed to the serving network where the mobile device is registered. This is done using standard IP based multicast protocols. Second, in each serving network the data is delivered to mobile devices using air interface multicast protocols.

Multicast downloading management of the present invention uses architecture and a call flow. The architecture is generally shown in FIG. 2. This section describes how the device management (DM) framework can be used for downloading management. FIG. 2 is based on a standard 3GPP2 NAM. The service provider 22 is an IP based entity, which distributes software. Associated with the service provider is the management server 24. The system can also have a software distribution center 25. In this architecture, the foreign agent (FA) 26 is capable of multicast routing. If multicast routing is not supported, the home agent (HA) 28 will tunnel the multicast packets using mobile IP. There are several proposals on IP multicast for mobile devices including those described in the following:
IP Multicast for Mobile Hosts, George Xylomenos, George C. Polyzos, IEEE Communications Magazine, 1997.
Secure Multicast Software Delivery, Lin Han, Nahid Shahmehri, IEEE 2000.
Supporting IP Multicast for Mobile Hosts, Yu Wang, Weidond Chen, Mobile Networks and Applications, Kluwer Academic, 2001.
End-to-End IP Multicast for Software Upgrades of Reconfigurable User Terminals within IMT-2000/UMTS networks, IEEE, 2002.

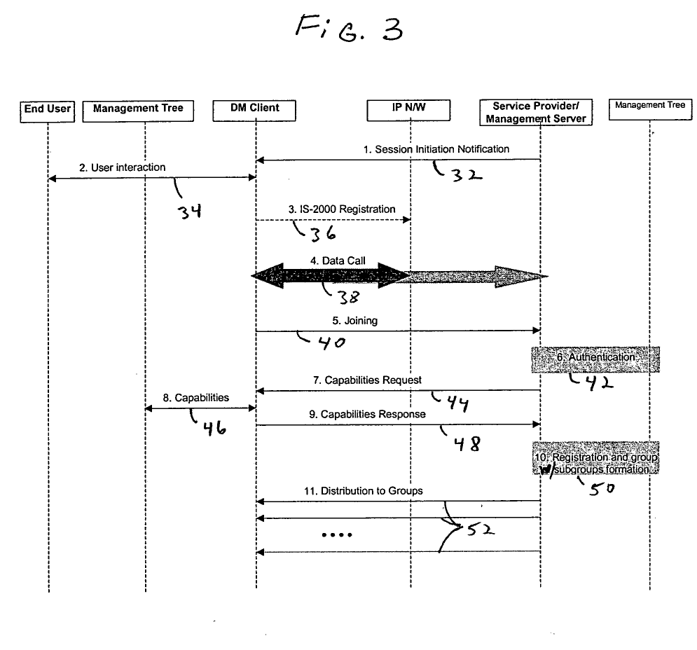

Referring also to FIG. 3, the service provider announces 32 a software update. This can be the SyncML DM notification message specified in SyncML Notification Initiated Session, version 1.1.1, October 2002 noted above. SyncML DM package #0 message can specify this. User interaction is required in most cases of software update. The user should be notified about the notification from the server. The user may choose to update the software, or postpone it to a later time, or decline. For this example, it is assumed that the user accepted.

The device manager (DM) client in the mobile device 30 initiates 34 the request. IS-2000 registration process 36 begins. A data call is established 38 with the server. The user joins 40 the group by sending a package #1 message. The package #1 can also message contain parameters for authentication. The service providing server authenticates 42 the client. The server may access the management database to verify client credentials as part of the authentication process. Additionally the server may request an authentication PIN from the user.

After the client is authenticated, the server requests 44 the capabilities of the client. This step is not required if the multicast capabilities are stored in the DevInfo and sent in package #1. The DM client in the mobile device accesses 46 the management tree in the mobile device for the capabilities. The DevInfo extensions can be programmed to store client capabilities for multicast support or it can be an object in the management tree. This should include parameters like Server identification, Multicast Protocol support, Multicast Group ID, Member ID, Multicast address, Device Type, etc. The parameters can also include information about operating system, provisioned services, applications installed and/or user convenience.

The client sends 48 the capabilities response in a SyncML DM message. Based on the capabilities of all the devices that joined the group, the server forms 50 subgroups. There can be one group for all the devices or several subgroups based on device type and capabilities. The management server forms 24 the groups and/or subgroups. The service-providing server distributes 52 software over multicast protocol to each multicast group/subgroups by system 20.

The present invention presents a framework that enables multicast downloading of software over-the-air (OTA) to diverse mobile devices. The present invention can be used as a contribution to the standardization of device management technology. The invention presents a method for the management of multicast data delivery to mobile devices. The invention introduces a method by which diverse mobile devices can receive data delivered using multicast protocols in an efficient way.

The invention provides a framework for the management of multicast delivery, thus allowing efficient delivery of data to mobile devices and using different multicast protocols. Currently there is no mechanism to manage software delivery to mobile devices. Even device management protocols developed in standards bodies consider only management of configuration data. Diversity is a characteristic of mobile devices; diversity in operating software, models, protocols supported. In such a heterogeneous environment, updating large amount of data sequentially (unicast) to mobile devices, is not efficient as it may require thousands of mobile devices to be updated with software one by one. Compared with fixed networks, this process is time consuming and expensive in wireless network and mobile devices.

The invention provides a method for the mobile devices to receive software updates, in an efficient way, based on mobile device capabilities. It allows mobile users to receive software appropriate for the device or correct updates to existing software. For the service provider, it also reduces the cost of software update and facilitates the introduction of a wide variety of applications and services to mobile hosts. The invention will thus help the wide spread use of mobile services, since enabling a service in mobile devices requires installing or updating of software data. Also data updates will ensure continuity of services and improvements in quality of service.

The distribution system determines how to download the data or what type of data to download to the mobile devices based upon the subgroup assignment. For example, the mobile devices assigned to a subgroup 1 might have a common first server identification, a common first protocol support and a common first device type. The mobile devices assigned to a subgroup 2 might a different common second server identification, a different common second protocol support and a different common second device type. The distribution system 20 could tailor or configure data delivery based upon the common multicast capabilities in each group. The data delivery configurations could be pre-established and the mobile devices assigned to the subgroups as the mobile devices join. The data delivery configurations could alternatively or additionally be dynamically created as mobile devices join. In addition to software updating, features of the present invention could also be used in other types of multicast delivery including real time audio and video streaming such as education and training, live concerts, sports events, etc.; application and service provisioning such as provisioning of user services and applications; software bug fixing and upgrades; update of large data blocks such as configuration parameter blocks; digital signal processing software and radio access technology software such as for multimode reconfigurable mobile devices; and messaging services such as weather alerts, news, etc.

Existing proposals do not consider the requirements in wireless networks. The current invention proposes the use of device management methods, which is new. Also, the invention introduces a two-step process of multicast delivery—delivery to the serving network and delivery within the serving network over air interface protocols. The idea of forming subgroups and multicast management tree, which is different from traditional multicast tree, is also new. Though the invention uses the 3GPP2 architecture as an example, the method can be extended to other wireless networks.

The multicast protocol used can vary depending on subgroups. The software send by use of the present invention can comprise operating system software, patches, device firmware, embedded software, which can vary depending on such parameters as vendor of the mobile device, make of the mobile device, features and applications in the mobile device. In one type of embodiment, the server can store the multicast capabilities of the mobile devices for future use. The server can use stored data for dynamically creating new subgroups for server initiated multicast updates, as when there is a patch for operating system or firmware of any similar need.

The system or device can also have intermediate management nodes which are based on multicast subgroups. The intermediate node is preferably in the device, and is part of the management tree. These intermediate nodes are based on multicast subgroups (i.e., each intermediate node for a multicast subgroup). There is the “actual node” corresponding to the intermediate node, which only the authorized entity in the device can access. The authorized entity can be the user, the management client in the device, an application, or a service which is provisioned in the device. The data updated to the intermediate node can be transferred to the actual node by the authorized entity.

In a preferred embodiment, each server knows its intermediate node in the device management tree and a management server can access only its corresponding intermediate multicast node for a specific multicast delivery. When data (e.g. device firmware, embedded software) is delivered by the management server using multicast methods, the data is updated to the intermediate node in the device. Only the authorized entity in the device (user, application, services, management client, etc.; depending on the rights) can access the “Actual node” corresponding to this received data. The authorized entity will access the intermediate node (received data and any other information received in the multicast reception process which is recorded in the intermediate node) and allows the device to now use the data internally (e.g., using the data to change internal settings, replacing old data in the device with new received data, etc.) This method ensures security. With this preferred method, an entity outside the device (in this example the management server) cannot manipulate internal components. An outside entity can only access the intermediate node in the management tree of the device; which merely carries limited information needed for successful multicast delivery and not automatic implementation or application of the delivered data.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method for wireless multicast downloading of data to mobile devices comprising steps of:
determining multicast capabilities of the mobile devices;
assigning each of the mobile devices to one of a plurality of subgroups of the mobile devices, subgroup assignment of the mobile devices being based upon at least one of the multicast capabilities of the mobile devices; and
determining how to download the data or what type of data to download to the mobile devices based upon the subgroup assignment.

2. A method as in claim 1 further comprising requesting download of the data from a service provider to the mobile devices by users of the mobile devices.

3. A method as in claim 2 wherein the step of determining multicast capabilities of the mobile devices comprises at least one of the mobile devices sending its multicast capabilities to a management server of the service provider when requesting the download of the data from the service provider.

4. A method as in claim 3 wherein the multicast capabilities of the at least one mobile device are stored in a DevInfo extension.

5. A method as in claim 1 wherein the multicast capabilities of the mobile devices are selected from a group comprising server identification, multicast protocol support, multicast Group ID, member ID, multicast address, device type, and information about operating system, provisioned services, applications installed and/or user convenience.

6. A method as in claim 2 wherein the step of determining multicast capabilities of the mobile devices comprises a server of the service provider requesting the multicast capabilities of at least one of the mobile devices, the at least one mobile device accessing a management tree in the at least one mobile device, and the at least one mobile device sending the multicast capabilities to the server.

7. A method as in claim 6 wherein the multicast capabilities are sent to the server in a SyncML DM message.

8. A method as in claim 1 wherein the step of assigning comprises a management server at a service provider providing the subgroup assignment of the mobile devices.

9. A method as in claim 1 wherein the data comprises software and wherein a server of a service provider distributes the software over multicast protocol to each multicast subgroups.

10. A method as in claim 9 wherein the multicast protocol used varies depending on subgroups.

11. A method as in claim 9 wherein the software comprises operating system software, patches, device firmware, embedded software, which can vary depending on such parameters as vendor of the mobile device, make of the mobile device, features and applications in the mobile device.

12. A method as in claim 1 further comprising authenticating the mobile devices by a server at a service supplier.

13. A method for wireless multicast downloading of data to a mobile device comprising steps of:
requesting download of the data from a service provider to the mobile device by a user of the mobile device;
sending multicast capability information regarding the mobile device to a management server at the service provider;
grouping identification of the mobile device in a group or subgroup with at least one other mobile device requesting a similar download, the group or subgroup being organized based upon at least one common multicast capability in the multicast capability information of the mobile devices; and
determining how to download the data to the mobile device based upon its grouping and the at least one common multicast capability.

14. A method as in claim 13 further comprising determining multicast capabilities of the mobile device.

15. A method as in claim 14 wherein the server stores the multicast capabilities of the mobile devices for future use.

16. A method as in claim 13 wherein the server uses the stored data for dynamically creating new subgroups for server initiated multicast updates, as when there is a patch for operating system or firmware of any similar need.

17. A method as in claim 13 wherein the step of requesting the download of the data from the service provider occurs at a same time as the step of sending the multicast capability information.

18. A method as in claim 13 wherein the multicast capabilities of the mobile device are stored in a DevInfo extension which is sent to the service provider.

19. A method as in claim 13 wherein the multicast capabilities of the mobile device is selected from a group comprising server identification, multicast protocol support, multicast Group ID, member ID, multicast address, and device type.

20. A method as in claim 13 wherein the step of sending multicast capability information of the mobile device comprises a server of the service provider requesting the multicast capabilities of the mobile device, the mobile device accessing a management tree in the mobile device, and the mobile device sending the multicast capability information to the server in a SyncML DM message.

21. A method as in claim 13 wherein the step of grouping comprises the management server at a service provider providing the subgroup of the mobile devices.

22. A method as in claim 13 wherein the data comprises software and wherein a server of the service provider distributes the software over multicast protocol to each multicast group or subgroup.

23. A method as in claim 22 wherein the multicast protocol used varies depending on subgroups.

24. A method as in claim 13 further comprising authenticating the mobile device by a server at the service supplier.

25. A system for managing multicast downloading of data from a service provider to mobile devices having different multicast reception capabilities, the system comprising:
means for determining information regarding the multicast reception capabilities of individual ones of the mobile devices and transmitting the information to a management server at a service provider;
means for assigning the mobile devices to subgroups by the management server based upon commonality of information in the multicast reception capabilities information of the mobile devices; and
means for transferring the data to the mobile devices in each subgroup, the means for transferring being adapted to individually configure data transmission for each of the subgroups based upon common or similar information in the multicast reception capability information for the mobile devices for that subgroup.

26. A system as in claim 25 wherein the multicast reception capabilities information is selected from a group comprising server identification, multicast protocol support, multicast Group ID, member ID, multicast address, device type, and information about operating system, provisioned services, applications installed, and user convenience.

27. A system as in claim 25 wherein the mobile devices each comprise a first management tree and the management server comprises a second different management tree, the second management tree having the subgroups separated by the multicast reception capabilities information commonality.

28. A method for wireless multicast downloading of data to a mobile device comprising steps of:
providing a device having a management tree with a plurality of intermediate nodes, wherein the intermediate nodes are based upon different multicast transmission subgroupings;
delivering data by multicast transmission from a first server to a first one of the intermediate nodes of the device based upon the multicast transmission subgrouping of the first intermediate node and a multicast subgrouping of the data transmission, wherein the data is constrained in the intermediate node until released by an authorized entity; and
releasing the data from the intermediate node to an actual node of the device by the authorized entity for use of the data by the device.

29. A method as in claim 28 further comprising limiting delivery of the data from the first server to the first intermediate node and limiting delivery of date from a second server to a second one of the intermediate nodes, wherein the servers can access only the corresponding intermediate multicast nodes for corresponding specific multicast deliveries.
